(19) United States
(12) Patent Application Publication
(10) Pub. No.: US 2006/0039151 A1
(43) Pub. Date: Feb. 23, 2006

(54) Planar light source device and liquid crystal display device having the same

(76) Inventors: Dong-Hoon Kim, Seoul (KR); Jong-Dae Park, Seoul (KR); Jin-Sung Choi, Yongin-si (KR)

Correspondence Address: CANTOR COLBURN, LLP, 55 GRIFFIN ROAD SOUTH, BLOOMFIELD, CT, 06002, US

(21) Appl. No.: 11/159,900

(22) Filed: Jun. 23, 2005

(30) Foreign Application Priority Data
Aug. 21, 2004 (KR) 2004-66156

(51) Int. Cl. G02F 1/1335

(52) U.S. Cl. 362/260; 349/70

(57) ABSTRACT

A planar light source device includes a planar fluorescent lamp and a luminance enhancing film. The planar fluorescent lamp includes first and second substrates, a sealing member and at least one partition member. The first substrate has a plate shape. The second substrate faces the first substrate. The second substrate includes light diffusing beads. The sealing member is disposed along edge portions of the first and second substrates to combine the first and second substrates. The at least one partition member is interposed between the first and second substrate to define discharge spaces. The luminance enhancing film is attached on an outer surface of the second substrate.

This application claims priority to Korean Patent Application No. 2004-66156 filed on Aug. 21, 2004, and all the benefits accruing therefrom under 35 U.S.C §119, and the contents of which in its entirety are herein incorporated by reference.

### BACKGROUND OF THE INVENTION

1. Field of the Invention

The present invention relates to a light source device and a liquid crystal display device having the light source device. More particularly, the present invention relates to a planar light source device and a liquid crystal display device having the planar light source device.

2. Description of the Related Art

A liquid crystal display (LCD) device displays images by using liquid crystal. The LCD device has many merits, such as a thin thickness, a low power consumption, a low driving voltage, etc. Therefore, the LCD device is used in various fields.

The LCD device emits no light, but requires light to display images. Therefore, the LCD device employs a light source device. Conventionally, a cold cathode fluorescent lamp (CCFL) was used for the light source device. The light source device may be classified as an edge illumination type or a direct illumination type according to a position of a lamp.

In an edge illumination type light source device, one or two lamps are disposed at a side face of a light guide plate, so that light generated from the one or two lamps enters the light guide plate through the side face and exits the light guide plate through an upper face of the light guide plate. Therefore, the edge illumination type light source device provides an LCD panel with light indirectly.

In a direct illumination type light source device, a plurality of lamps are disposed parallel to each other under a diffusion plate, and an LCD panel is disposed over the diffusion plate. Therefore, the direct illumination type light source device provides the LCD panel with light directly.

However, both the edge illumination type light source device and the direct illumination type light source device have disadvantages such as a low light-using efficiency, a low uniformity of luminance, a high manufacturing cost, etc.

Therefore, a planar light source device has recently been developed. The planar light source device includes an upper plate, a lower plate and at least one partition wall interposed between the upper and lower plates to define discharge spaces. When a discharge voltage is applied to the discharge spaces, discharge gas emits ultraviolet light due to plasma discharge. The ultraviolet light is converted into visible light by a fluorescent layer disposed at an inner face of the upper and lower plates.

However, the planar light source device also has luminance that is non-uniform due to the at least one partition wall. Therefore, the planar light source device also requires a diffusion plate or a diffusion sheet. The diffusion plate or diffusion sheet lowers a light-using efficiency and increases a thickness of the planar light source device.

### SUMMARY OF THE INVENTION

The present invention provides a planar light source device capable of reducing manufacturing cost, enhancing light-using efficiency and reducing thickness of a liquid crystal display (LCD) device. The present invention also provides an LCD device having the planar light source device.

In an exemplary planar light source device according to the present invention, the planar light source device includes a planar fluorescent lamp and a luminance enhancing film. The planar fluorescent lamp has discharge spaces. The planar fluorescent lamp emits light. The luminance enhancing film is attached to the planar fluorescent lamp.

In another exemplary planar light source device according to the present invention, the planar light source device includes a planar fluorescent lamp and a luminance enhancing film. The planar fluorescent lamp includes first and second substrates, a sealing member and at least one partition member. The first substrate has a plate shape. The second substrate faces the first substrate. The second substrate includes light diffusing beads. The sealing member is disposed along edge portions of the first and second substrates to combine the first and second substrates. The at least one partition member is interposed between the first and second substrates to define discharge spaces. The luminance enhancing film is attached on an outer surface of the second substrate.

In an exemplary liquid crystal display (LCD) device according to the present invention, the LCD device includes a planar light source device, an LCD panel and an inverter. The planar light source device includes a planar fluorescent lamp and a luminance enhancing film. The planar fluorescent lamp has discharge spaces. The planar fluorescent lamp emits light. The luminance enhancing film is attached to the planar fluorescent lamp. The LCD panel displays images using the light. The inverter outputs discharge voltages for driving the planar light source device.

Therefore, the LCD device no additional light-diffusing plate or light-diffusing sheet is required, so that a thickness of the planar light source device and manufacturing cost are reduced. Furthermore, leakage of light is reduced to enhance luminance and light-using efficiency.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is an exploded perspective view illustrating a planar light source device according to an exemplary embodiment of the present invention;

FIG. 2 is a cross-sectional view illustrating the planar light source device in FIG. 1;

FIG. 3 is a schematic plan view illustrating a connection path of the planar light source device in FIG. 1;

FIG. 4 is a perspective view illustrating another exemplary connection path that may be applied to the planar light source device in FIG. 1;

FIG. 5 is an enlarged view illustrating a portion ‘A’ in FIG. 4;

FIG. 6 is a perspective view illustrating a backside of the planar light source device in FIG. 1;

FIG. 7 is a perspective view illustrating first and second electrodes according to another exemplary embodiment;

FIG. 8 is a cross-sectional view illustrating a luminance enhancing film in FIG. 1;

FIG. 9 is a schematic view illustrating another luminance enhancing film in FIG. 1;

FIG. 10 is a schematic view illustrating molecules of a liquid crystal layer of the luminance enhancing film in FIG. 9;

FIG. 11 is an exploded perspective view illustrating a planar light source device according to another exemplary embodiment of the present invention;

FIG. 12 is a cross-sectional view illustrating the planar light source device in FIG. 11;

FIG. 13 is an exploded perspective view illustrating a planar light source device according to still another exemplary embodiment of the present invention; and

FIG. 14 is an exploded perspective view illustrating a liquid crystal display device according to an exemplary embodiment of the present invention.

### DETAILED DESCRIPTION OF THE INVENTION

Hereinafter exemplary embodiments of the present invention will be described in detail with reference to the accompanied drawings.

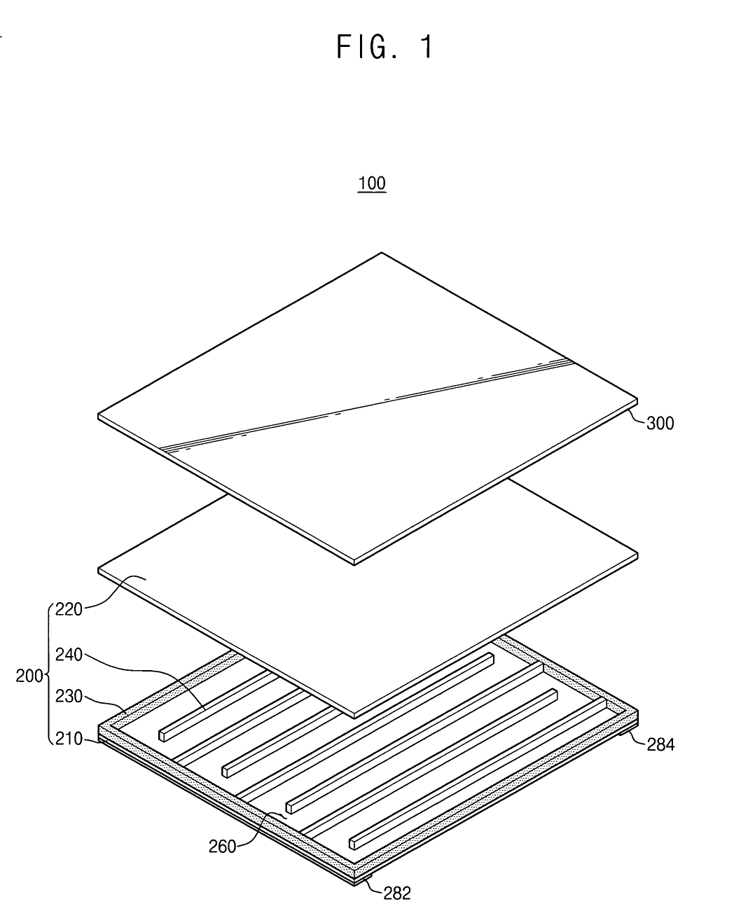

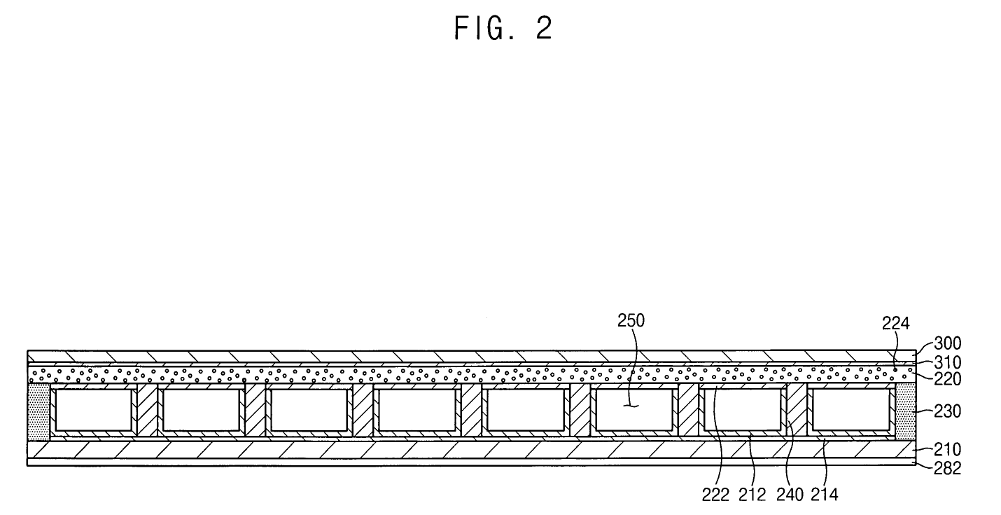

FIG. 1 is an exploded perspective view illustrating a planar light source device according to an exemplary embodiment of the present invention, and FIG. 2 is a cross-sectional view illustrating the planar light source device in FIG. 1.

Referring to FIGS. 1 and 2, a planar light source device 100 according to an exemplary embodiment of the present invention includes a planar fluorescent lamp 200 and a luminance enhancing film 300. The planar fluorescent lamp 200 includes discharge spaces 250 that are disposed parallel to each other. The luminance enhancing film 300 is attached to a surface of the planar fluorescent lamp 200.

The planar fluorescent lamp 200 includes a first substrate 210, a second substrate 220, a sealing member 230 and at least one partition member. In this exemplary embodiment, the planar fluorescent lamp 200 includes multiple partition members 240.

The first substrate 210 has a plate shape. The first substrate 210 corresponds to, for example, a glass substrate. The second substrate 220 has a substantially identical shape or a same shape as the first substrate 210. The second substrate 220 corresponds to, for example, a glass substrate. The first and second substrates 210 and 220 are combined together via the sealing member 230 to define an inner space interposed between the first and second substrates 210 and 220. The first and second substrates 210 and 220 may include material that prevents leakage of ultraviolet light.

The sealing member 230 is disposed along edges of the first and second substrates 210 and 220 to combine the first and second substrates 210 and 220. The sealing member 230 may include a same material as the first and second substrates 210 and 220. The sealing member 230 includes, for example, glass. The sealing member 230 is attached to the first and second substrates 210 and 220 by glue or adhesive such as, for example, frit that is a composition of glass and metal and has a lower melting point than glass.

The partition members 240 are interposed between the first and second substrates 210 and 220 to divide the inner space into the discharge spaces 250. Each of the partition members 240 has a rod shape. The partition members 240 are arranged parallel to each other. The partition members 240 may be spaced equal distances apart from each other. Each of the partition members 240 includes, for example, glass, and is attached to the first and second substrates 210 and 220 with adhesive, such as frit.

A dispenser may squeeze melted glass to form the partition members 240. A cross-section of the partition members 240 has, for example, a rectangular shape in FIG. 2. Alternatively, the partition members 240 may have a trapezoidal shape or a rounded shape. The planar fluorescent lamp 200 may further include a first fluorescent layer 212, a second fluorescent layer 222 and a light reflecting layer 214.

The first fluorescent layer 212 is disposed at an inner surface of the first substrate 210 and a side face of the partition members 240. The second fluorescent layer 222 is disposed at an inner surface of the second substrate 220. Therefore, the first and second fluorescent layers 212 and 222 surround each of the discharge spaces 250. The first and second fluorescent layers 212 and 222 convert ultraviolet light generated from discharge gases in the discharge spaces 250 into visible light through plasma discharge.

The light-reflecting layer 214 is interposed between the first substrate 210 and the first fluorescent layer 212. The light-reflecting layer 214 reflects visible light toward the second substrate 220 to prevent the leakage of the visible light through the first substrate 210. The light-reflecting layer 214 may include a metal oxide in order to enhance reflectivity and reduce changes of color coordinates. The light-reflecting layer 214 includes, for example, aluminum oxide (Al₂O₃) or barium sulfate (BaSO₄). The aluminum oxide (Al₂O₃) or barium sulfate (BaSO₄) may be coated on the first substrate 210 to form the light-reflecting layer 214. The light-reflecting layer 214 has a thickness of about 20 μm to about 100 μm. The light-reflecting layer 214 has a density of about 5 g/cm² to about 12 g/cm².

The planar fluorescent lamp 200 may further include a protection layer (not shown). The protection layer may be interposed between the second substrate 220 and the second fluorescent layer 222. The protection layer may be interposed between the first substrate 210 and the light-reflecting layer 214. The protection layer prevents chemical reactions from impacting the first and second substrates 210 and 220, and a gas discharge of mercury gas in the discharge spaces. Therefore, the mercury gas in the discharge spaces is maintained.

The planar fluorescent lamp 200 having above-explained structure emits visible light through the second substrate 220. The second substrate 220 further includes a light diffusion member 224. The light diffusion member 224 includes a plurality of particles. The light diffusion member 224 is disposed in the second substrate 220. In other words, a plurality of particles are injected into the second substrate 220 during manufacturing of the second substrate 220. The light diffusion member 224 may include, for example, polymethyl methacrylate (PMMA). The particles of the diffusion member 224 may be bead shaped. The light diffusion member 224 diffuses light in order to remove dark lines displayed on the second substrate due to the partition members 240.

The planar fluorescent lamp 200 includes connection paths 260 that connect the discharge spaces 250 to each other.

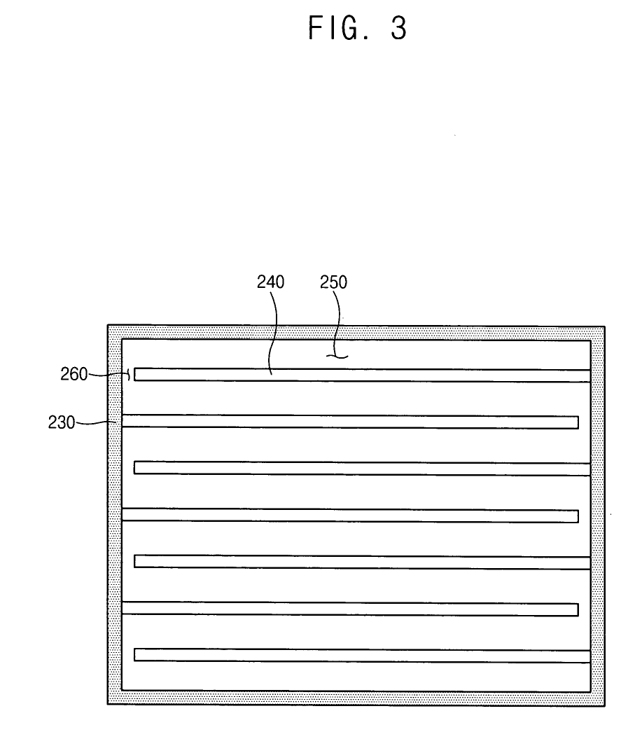

FIG. 3 is a schematic plan view illustrating a connection path of the planar light source device in FIG. 1.

Referring to FIGS. 1 and 3, at least one end portion of each of the partition members 240 is spaced apart from the sealing member 230 to define the connection paths 260. In other words, the connection paths 260 formed proximate to each of the partition members 240 are alternately disposed at first and second sides of the planar fluorescent lamp 200

For example, second ends of odd-numbered partition members 240 make contact with the sealing member 230, and first ends of even-numbered partition members 240 make contact with the sealing member 230. Therefore, the discharge spaces 250 are connected to each other through the connection paths 260 to form a serpentine shape.

As described above, when the connection paths 260 are disposed alternately at the first and second sides of the planar fluorescent lamp 200, an interference between each of the discharge spaces 250 may be reduced to prevent a channeling phenomenon, during which all current flows through only one of the discharge spaces 250.

Plasma gas for plasma discharge is injected into the discharge spaces 250. The plasma gas includes, for example, mercury (Hg), neon (Ne), argon (Ar), xenon (Xe), krypton (Kr), etc. The plasma gas is injected into only one of the discharge spaces 250. However, the plasma gas moves to other discharge spaces 250 though the connection paths 260 to spread uniformly throughout the discharge spaces 250.

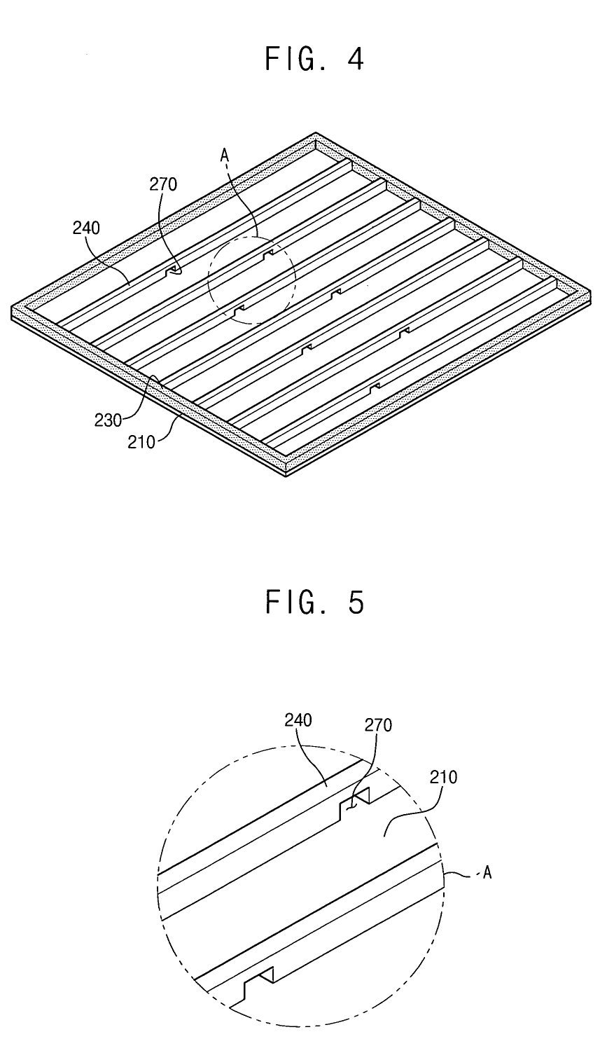

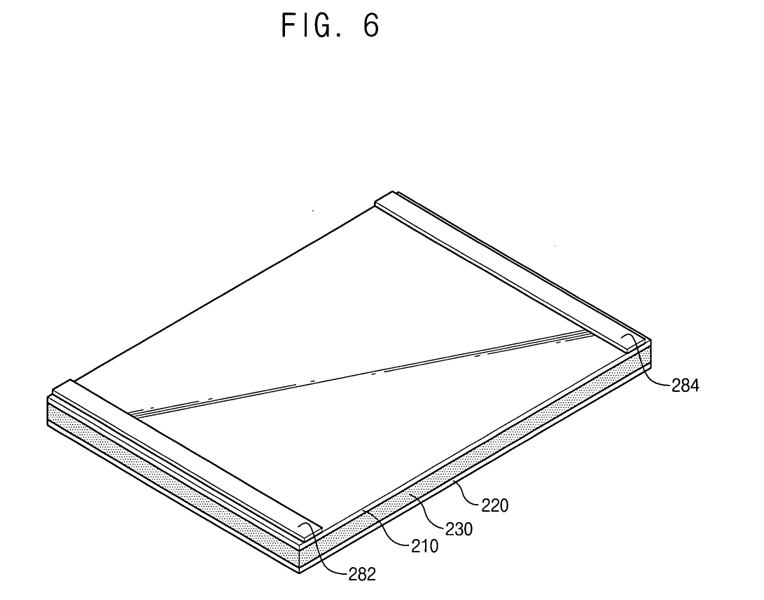

FIG. 4 is a perspective view illustrating another exemplary connection path that may be applied to the planar light source device in FIG. 1, and FIG. 5 is an enlarged view illustrating a portion ‘A’ in FIG. 4.

Referring to FIGS. 4 and 5, both ends of each of the partition members 240 make contact with the sealing member 230. Each of the partition members 240 includes at least one connection path 270. The partition members 240 may include a portion having a thinner thickness than other portions. The portion having the thinner thickness corresponds to the at least one connection path 270. Alternatively, each of the partition members 240 may include a hole or orifice that corresponds to a connection path 270. As another alternative, each of the partition members 240 may be broken into more than one piece to form the connection path 270. In other words, two partition members 240 are arranged along a line such that the partition members 240 are spaced apart from each other to define the connection path 270.

A position of the connection path 270 may be arbitrary. Therefore, the connection path 270 of each of the partition members 240 is not linearly arranged with the connection path 270 of adjacent partition members 240. In other words, a virtual straight line may not connect each connection path 270. For example, connection paths 270 may be arranged in a zigzag shape. In other words, the connection paths 270 of odd-numbered partition members 240 are disposed at a left side of the planar fluorescent lamp, and the connection paths 270 of even-numbered partition members 240 are disposed at a right side of the planar fluorescent lamp. Each of the partition members 240 may include more than one connection path 270.

The planar fluorescent lamp 200 further includes first and second electrodes 282 and 284.

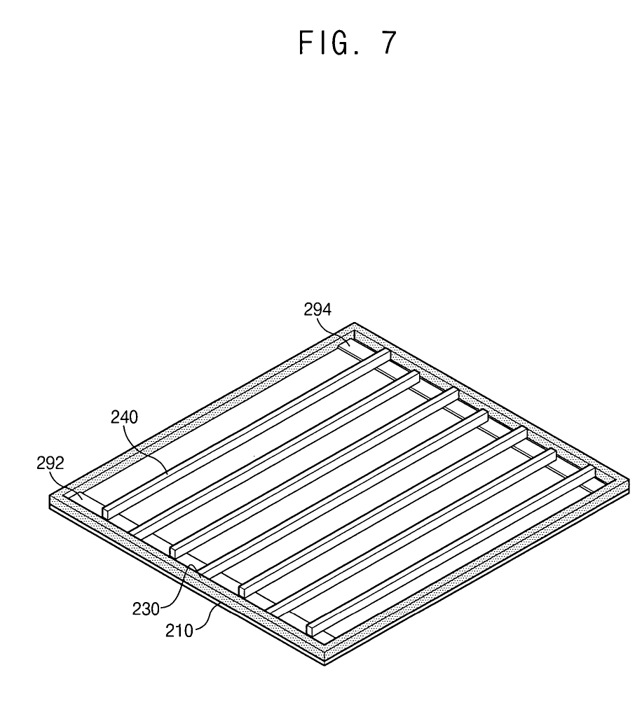

FIG. 6 is a perspective view illustrating a backside of the planar light source device in FIG. 1.

Referring to FIGS. 1 and 6, first and second electrodes 282 and 284 are disposed on an outer surface of the first substrate 210. The first and second electrodes 282 and 284 are disposed at oppositely disposed first and second end portions of the first substrate 210, respectively.

The first and second electrodes 282 and 284 are disposed such that a longitudinal direction of the first and second electrodes 282 and 284 is substantially perpendicular to a longitudinal direction of the partition members 240. Therefore, the first and second electrodes 282 and 284 cross all of the discharge spaces 250.

Alternatively, the first and second electrodes 282 and 284 may be disposed at an outer surface of the second substrate 220. As another alternative, the first and second electrodes 282 and 284 may be disposed at outer surfaces of both the first and second substrates 210 and 220.

The first and second electrodes 282 and 284 include metal having a low resistivity. The first and second electrodes 282 and 284 may include, for example, copper (Cu), nickel (Ni), gold (Au), aluminum (Al), chromium (Cr) or a mixture thereof.

Powder including copper (Cu), nickel (Ni), gold (Au), aluminum (Al), chromium (Cr) or a mixture thereof may be coated on the outer surface of the first substrate 210 by a spraying method to form the first and second electrodes 282 and 284.

For example, a mask is disposed on a center portion of the outer surface of the first substrate 210 to expose first and second end portions of the first substrate 210 at which the first and second electrodes 282 and 284 are to be disposed. Then, the powder including copper (Cu), nickel (Ni), gold (Au), aluminum (Al), chromium (Cr) or a mixture thereof is spray coated on the first and second end portions of the first substrate 210 to form the first and second electrodes 282 and 284, respectively.

Alternatively, a metal tape may be attached to the outer surface of the first substrate 210 to form the first and second electrodes 282 and 284. Alternatively, silver paste may be attached to the outer surface of the first substrate 210 to form the first and second electrodes 282 and 284.

The first and second electrodes 282 and 284 may include an optically transparent and electrically conductive material, such as indium tin oxide (ITO), indium zinc oxide (IZO), etc. The first and second electrodes 282 and 284 may be formed through a silk printing method, a deposition method, photolithography, etc.

The first and second electrodes 282 and 284 apply discharge voltages to the planar fluorescent lamp 200 to generate plasma discharge.

FIG. 7 is a perspective view illustrating first and second electrodes according to another exemplary embodiment.

Referring to FIG. 7, first and second electrodes 292 and 294 are disposed on the inner surface of the first substrate 210. The first and second electrodes 292 and 294 are disposed at first and second end portions of the first substrate 210, respectively. The first and second electrodes 292 and 294 are disposed such that a longitudinal direction of the first and second electrodes 292 and 294 is substantially perpendicular to a longitudinal direction of the partition members 240. Therefore, the first and second electrodes 292 and 294 cross all of the discharge spaces 250.

The planar fluorescent lamp 200 may further include a dielectric layer (not shown) for protecting the first and second electrodes 292 and 294. The dielectric layer is disposed such that the dielectric layer covers an entire inner surface of the first substrate 210 having the first and second electrodes 292 and 294 disposed thereon. Alternatively, the dielectric layer is disposed such that the dielectric layer covers the first and second electrodes 292 and 294 disposed at the first substrate 210.

The first and second electrodes 292 and 294 may be disposed only at an inner surface of the second substrate 220. Alternatively, the first and second electrodes 292 and 294 may be disposed at inner surfaces of both the first and second substrates 210 and 220.

Alternatively, one of the first and second electrodes 292 and 294 may be disposed at the inner surface of one or both of the first and second substrates 210 and 220 and a remaining one of the first and second electrodes 292 and 294 may be disposed at the outer surface of one or both of the first or second substrates 210 or 220.

Referring again to FIGS. 1 and 2, the luminance enhancing film 300 is attached to the outer surface of the second substrate 220 through which light exits the planar fluorescent lamp 200. The luminance enhancing film 300 transmits a portion of light, which satisfies a specific condition, and reflects another portion of light, which does not satisfy the specific condition, until the other portion of light does satisfy the specific condition, to enhance light-using efficiency.

The luminance enhancing film 300 is attached to the outer surface of the second substrate 220, for example through an adhesive layer 310. The adhesive layer 310 may include a haze value of about 0 and a transmittance of about 100% in order to minimize disturbance of the adhesive layer 310.

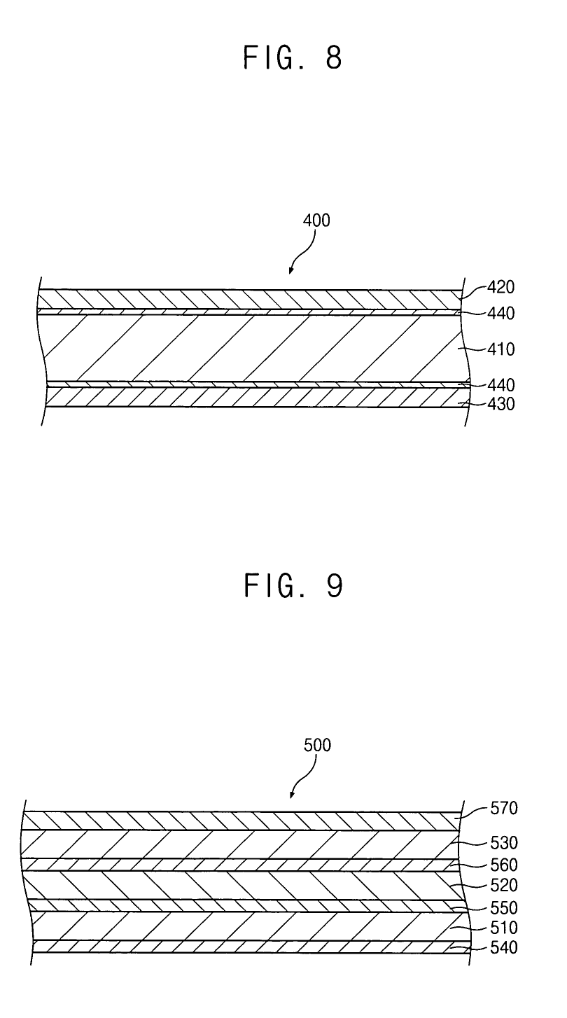

FIG. 8 is a cross-sectional view illustrating a luminance enhancing film in FIG. 1.

Referring to FIG. 8, the luminance enhancing film 300 includes a reflective type polarizing film 400 corresponding to a dual brightness enhancement film (DBEF) that transmits a P-wave component of light and reflects an S-wave component of light.

The reflective type polarizing film 400 includes a light-polarizing layer 410, a first protection layer 420 and a second protection layer 430. The first protection layer 420 is disposed at an upper face of the light-polarizing layer 410 and the second protection layer 430 is disposed at a lower face of the light-polarizing layer 410. The first and second protection layers 420 and 430 may be attached, for example, by an adhesive 440 that may be hardened by ultraviolet light.

The light-polarizing layer 410 has a multi-layered structure. In other words, the light-polarizing layer 410 includes thin films piled up. Each of the thin films has a different refractivity. The light-polarizing layer 410 includes, for example, hundreds or thousands of the thin films. The first and second protection layers 420 and 430 attached to the upper and lower faces of the light-polarizing layer 410, respectively, protect the light-polarizing layer 410.

Light generated by the planar fluorescent lamp 200 includes a P-wave component and an S-wave component. The light-polarizing layer 410 transmits the P-wave component, and reflects the S-wave component. The S-wave component reflected by the light-polarizing layer 410 may be converted into the P-wave component by the light-reflecting layer 214, to be transmitted by the light-polarizing layer 410. Therefore, light-using efficiency is enhanced.

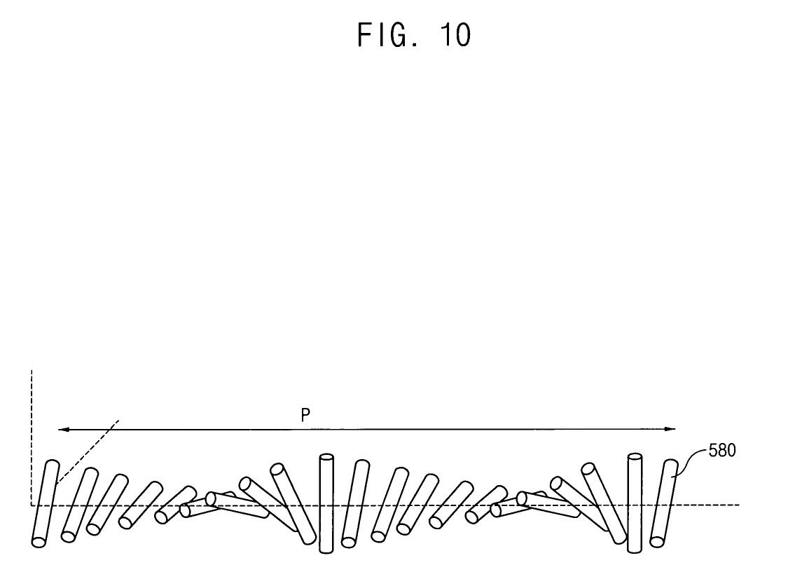

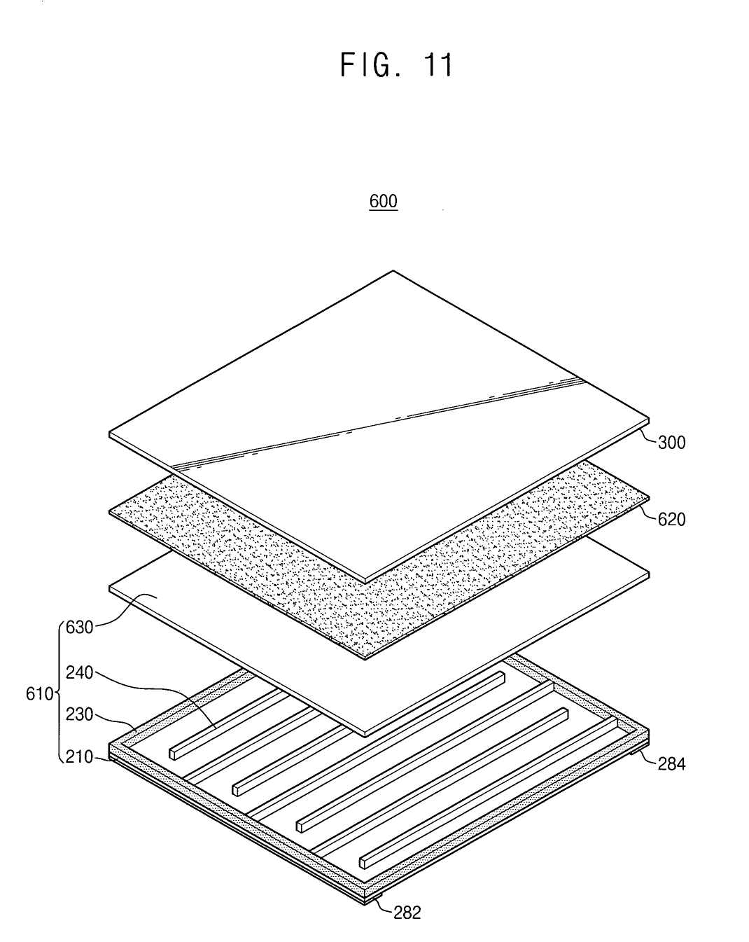

FIG. 9 is a schematic view illustrating another luminance enhancing film in FIG. 1, and FIG. 10 is a schematic view illustrating molecules of a liquid crystal layer of the luminance enhancing film in FIG. 9.

Referring to FIGS. 9 and 10, a luminance enhancing film includes a cholesteric liquid crystal (CLC) film 500 that transmits light having a specific wavelength and reflects light having any other wavelength.

The CLC film 500 includes first, second and third liquid crystal layers 510, 520 and 530, first, second and third base films 540, 550 and 560, and a retardation film 570. The first, second and third base films 540, 550 and 560 and the first, second and third liquid crystal layers 510, 520 and 530 are alternately disposed. In other words, the first liquid crystal layer 510 is disposed between the first and second base films 540 and 550, the second liquid crystal layer 520 is disposed between the second and third base films 550 and 560, the third liquid crystal layer 530 is disposed between the third base film 560 and the retardation film 570. The first, second and third base films 540, 550 and 560 include, for example polyethylene terephthalate (PET).

The first, second and third liquid crystal layers 510, 520 and 530 are hardened in response to irradiation by ultraviolet light. Liquid crystal in a monomer state is coated and ultraviolet light is irradiated onto the liquid crystal, so that the liquid crystal is polymerized to form the first, second and third liquid crystal layers 510, 520 and 530. The first, second and third liquid crystal layers 510, 520 and 530 include cholesteric liquid crystal molecules 580 having a rod shape and being twisted in orientation with respect to each other.

Twisting of the cholesteric liquid crystal molecules 580 is periodic. A periodic distance, or distance between cholesteric liquid crystal molecules 580 having a same orientation with respect to an axis about which the cholesteric liquid crystal molecules 580 are twisted, is referred to as a pitch ‘P’. The first, second and third liquid crystal layers 510, 520 and 530 each have a different pitch. For example, the first liquid crystal layer 510 has a pitch corresponding to a red color, the second liquid crystal layer 520 has a pitch corresponding to a green color, and the third liquid crystal layer 530 has a pitch corresponding to a blue color.

Each of the first, second and third liquid crystal layers 510, 520 and 530 reflects light having a wavelength that is substantially equal to a pitch ‘P’ times average refractivity of an extraordinary refractivity and an ordinary refractivity of liquid crystal.

Light reflected by the first, second and third liquid crystal layers 510, 520 and 530 has a right-handed circular polarization or a left handed circular polarization according to a twist direction of the cholesteric liquid crystal molecules 580. Light that is transmitted by the first, second and third liquid crystal layers 510, 520 and 530 has opposite polarization to the light that is reflected by the first, second and third liquid crystal layers 510, 520 and 530. The light reflected by one of the first, second and third liquid crystal layers 510, 520 and 530 is changed to be light that may be transmitted by others of the first, second and third liquid crystal layers 510, 520 and 530. Therefore, all visible light wavelengths are polarized to have a same polarization state.

The retardation film 570 corresponds to, for example, a quarter-wave plate that may convert circularly polarized light into linearly polarized light to reduce light leakage.

The CLC film 500 may include a plurality of liquid crystal layers, each of the liquid crystal layers reflecting light having a different wavelength in order to cover all wavelengths of visible light.

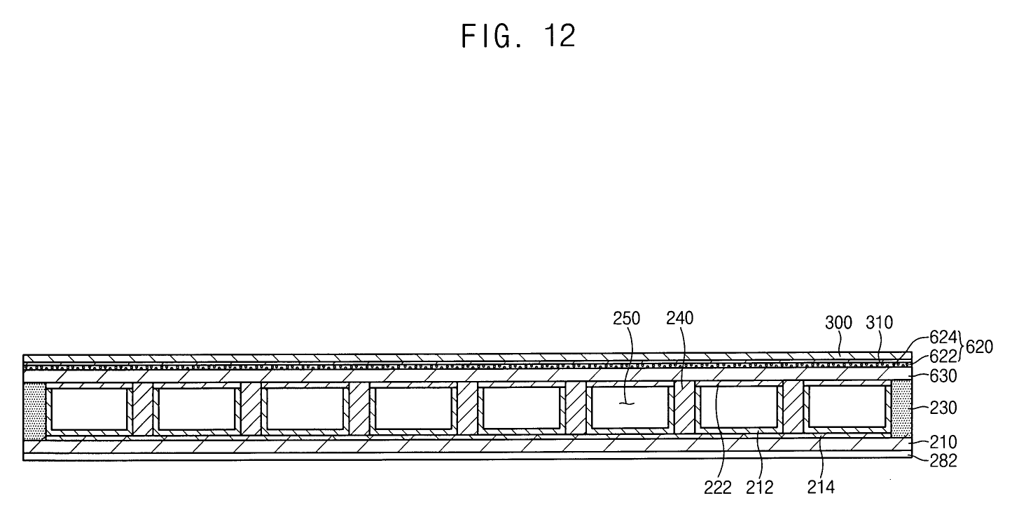

FIG. 11 is an exploded perspective view illustrating a planar light source device according to another exemplary embodiment of the present invention, and FIG. 12 is a cross-sectional view illustrating the planar light source device in FIG. 11. The planar light source device according to the present exemplary embodiment is the same as in previous exemplary embodiments of FIGS. 1 to 10, except for a second substrate and a light-diffusing layer disposed at an outer surface of the second substrate. Thus, the same reference numerals will be used to refer to the same or like parts as those described in the previous exemplary embodiments and any further explanation will be omitted.

Referring to FIGS. 11 and 12, a planar light source device 600 according to the present exemplary embodiment includes a planar fluorescent lamp 610, a light-diffusing layer 620 and the luminance enhancing film 300.

The planar fluorescent lamp 610 includes the first substrate 210, a second substrate 630, the sealing member 230 and the partition members 240. The first substrate 210 has the plate shape. The second substrate 630 faces the first substrate 210. The sealing member 230 is disposed along edges of the first and second substrates 210 and 630 to combine the first and second substrates 210 and 630. Therefore, an inner space is defined by the first and second substrates 210 and 630 and the sealing member 230.

The second substrate 630 does not include the light-diffusing member 224 of FIG. 2. However, the planar light source device 600 further includes the light-diffusing layer 620 disposed at an outer surface of the second substrate 630. The light-diffusing layer 620 may be interposed between the planar fluorescent lamp 610 and the luminance enhancing film 300.

The light-diffusing layer 620 includes diffusion beads 622 and a binding resin 624. The diffusion beads 622 include, for example PMMA. The binding resin 624 is hardened in response to irradiation by ultraviolet light to be attached to the outer surface of the second substrate 630. The light-diffusing layer 620 diffuses light that exits the planar fluorescent lamp 610 through the second substrate 630 to remove dark lines displayed due to the partition members 240. The luminance enhancing film 300 is attached to the light-diffusing layer 620 through the adhesive layer 310.

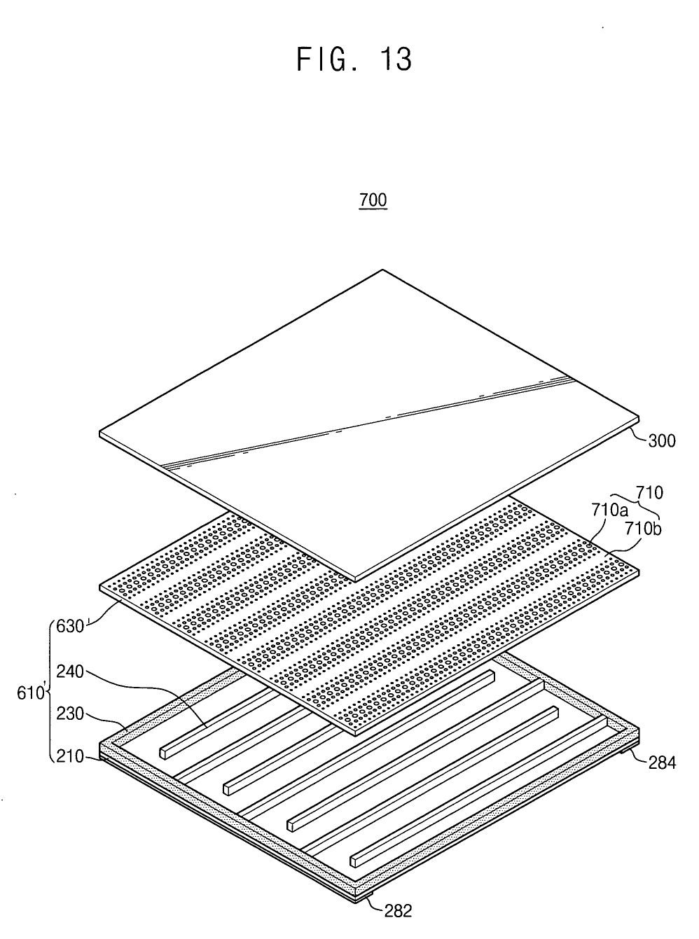

FIG. 13 is an exploded perspective view illustrating a planar light source device according to still another exemplary embodiment of the present invention. The planar light source device according to the present exemplary embodiment is same as in the previous exemplary embodiments of FIGS. 1 to 10 except for light diffusing patterns formed on an outer surface of a second substrate. Thus, the same reference numerals will be used to refer to the same or like parts as those described in the previous exemplary embodiments and any further explanation will be omitted.

Referring to FIG. 13, a planar light source device 700 according to the present exemplary embodiment includes a planar fluorescent lamp 610′ and the luminance enhancing film 300.

The planar fluorescent lamp 610′ includes the first substrate 210, a second substrate 630′ having light diffusing patterns 710, the sealing member 230 and the partition members 240.

The light diffusing patterns 710 may be formed, for example, on the outer surface of the second substrate 630′. The light diffusing patterns 710 may be formed on the outer surface of the second substrate 630′, for example, through a silk printing process. The light diffusing patterns 710 formed on the outer surface of the second substrate 630′ include a first pattern 710a having high density and a second pattern 710b having low density.

The first pattern 710a is disposed at a portion of the outer surface of the second substrate 630′ corresponding to a position of the discharge spaces 250, and the second pattern 710b is disposed at a portion of the outer surface of the second substrate 630′ corresponding to a position of the partition members 240. The light diffusing patterns 710 may be modulated to have various shapes.

The luminance enhancing film 300 is disposed at the second substrate 630′ having the light diffusing patterns 710 formed thereon.

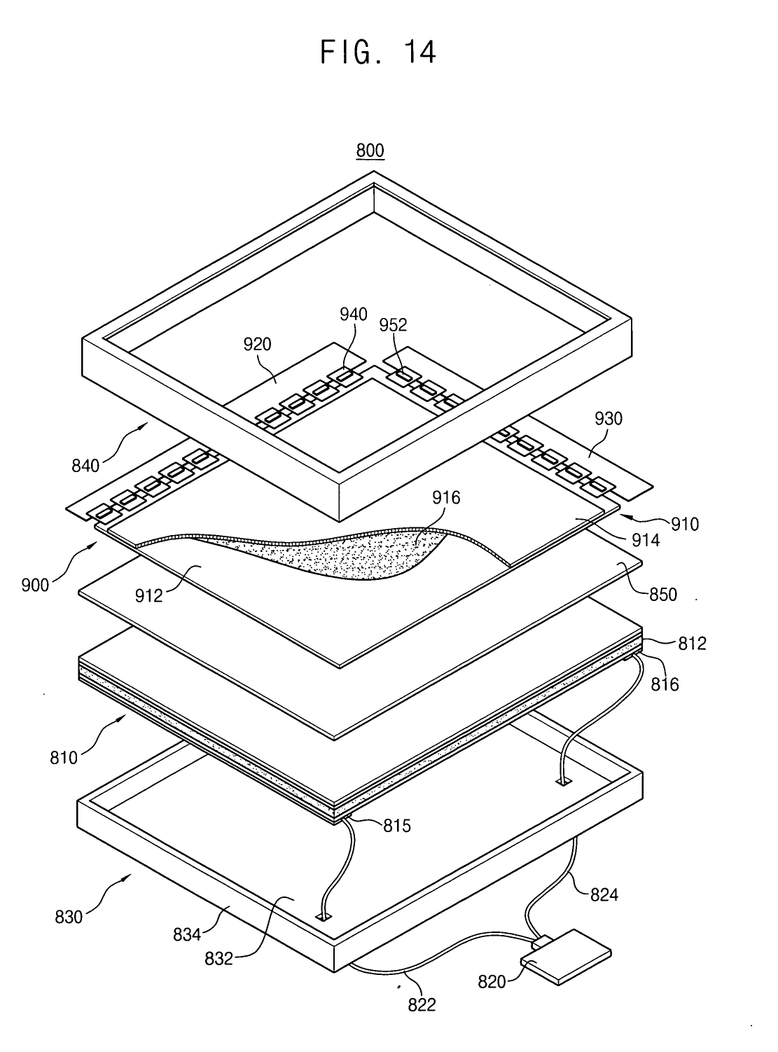

FIG. 14 is an exploded perspective view illustrating a liquid crystal display device according to an exemplary embodiment of the present invention.

Referring to FIG. 14, a liquid crystal display (LCD) device 800 according to the present exemplary embodiment includes a planar light source device 810, a display unit 900 and an inverter 820.

The planar light source device 810 may be substantially similar to one of the previous exemplary embodiments. Therefore, any further explanation for the planar light source device 810 will be omitted.

The display unit 900 includes an LCD panel 910 that displays images, and data and gate printed circuit boards (PCBs) 920 and 930 that provide the LCD panel 910 with driving signals. The data and gate PCBs 920 and 930 are combined with the LCD panel 910 through data and gate flexible printed circuits (FPCs) 940 and 950, respectively, so that the data and gate PCBs 920 and 930 apply the driving signals to the LCD panel 910 through the data and gate FPCs 940 and 950. The data and gate FPCs 940 and 950 may correspond to tape carrier package (TCP) or chip on film (COF). The data and gate FPCs 940 and 950 include data and gate driver chips, respectively. The data and gate driver chips apply the driving signals to the LCD panel 910 at a proper time.

The LCD panel 910 includes a thin film transistor (TFT) substrate 912, a color filter substrate 914 facing the TFT substrate 912 and a liquid crystal layer 916 interposed between the TFT substrate 912 and the color filter substrate 914.

The TFT substrate 912 includes a glass substrate having a plurality of TFTs disposed thereon. The TFTs are arranged substantially in a matrix shape. Each of the TFTs includes a source electrode that is electrically connected to a source line, a gate electrode that is electrically connected to a gate line, and a drain electrode that is electrically connected to a pixel electrode. The pixel electrode includes an optically transparent and electrically conductive material such as ITO, IZO, etc.

The color filter substrate 914 includes a glass substrate having red, green and blue color filters disposed thereon. The color filter substrate 914 also includes a common electrode including optically transparent and electrically conductive material such as ITO, IZO, etc.

In response to a gate voltage being applied to the gate electrode of a TFT, the TFT is turned on, so that a pixel voltage is applied to the pixel electrode through the TFT. Therefore, electric fields are formed between the pixel electrode of the TFT substrate 912 and the common electrode of the color filter substrate 914.

In response to electric fields being applied to liquid crystal between the pixel electrode and the common electrode, molecules of the liquid crystal are rearranged to change optical transmittance to display black and white images. The black and white images are converted into color images by color filters of the color filter substrate 914.

The inverter 820 generates discharge voltages for driving a planar fluorescent lamp 812. The inverter 820 receives an alternating voltage and boosts the alternating voltage to generate the discharge voltages. The discharge voltages are applied to first and second electrodes 815 and 816 of the planar light source device 810 through first and second wires 822 and 824, respectively.

When the first and second electrodes 815 and 816 are disposed at both external faces of the planar fluorescent lamp 812, the LCD device 800 may further include a clip (not shown) that electrically connects the first and second electrodes 815 and 816 disposed at both external faces of the planar fluorescent lamp 812 to the first and second wires 822 and 824, respectively.

The LCD device 800 further includes a receiving container 830 that receives the LCD panel 910 and a fixing member 840 that fixes the LCD panel 910 to the receiving container 830.

The receiving container 830 includes a bottom plate 832 for supporting the LCD panel 910, and sidewalls 834 extended from edge portions of the bottom plate 832.

The receiving container 830 may further include an insulating member (not shown) that electrically insulates the LCD panel 910 from the planar light source device 810.

The fixing member 840 surrounds edge portions of the LCD panel 910, and is combined with the receiving container 830 to fix the LCD panel 910 to the receiving container 830 such that the LCD panel 910 is disposed proximate to the planar light source device 810. The fixing member 840 protects the LCD panel 910, and prevents the LCD panel 910 from being separated from the receiving container 830. The fixing member 840 may include metal.

The LCD device 800 may further include an optical sheet 850. The optical sheet 850 may be interposed between the planar light source device 810 and the LCD panel 910. The optical sheet 850 may include a prism sheet for enhancing luminance and a diffusion sheet for enhancing uniformity of luminance.

The LCD device 800 may further include a mold frame (not shown) interposed between the planar light source device 810 and the LCD panel 910, surrounding the planar light source device 810 to fix the planar light source device 810 to the receiving container 830, guiding the LCD panel 910.

According to a planar light source device and a display device having the planar light source device, a second substrate of the planar light source device includes a plurality of light diffusing particles. Alternatively, a light diffusing layer or light diffusing patterns may be disposed at an outer surface of the second substrate of the planar light source device. Therefore, no additional light diffusing plate or no additional light-diffusing sheet is required, so that a thickness of the planar light source device and manufacturing cost are reduced. Furthermore, leakage of light is reduced to enhance luminance and light-using efficiency.

Having described exemplary embodiments of the present invention and their advantages, it is noted that various changes, substitutions and alterations can be made herein without departing from the spirit and scope of the invention as defined by appended claims.

What is claimed is:

1. A planar light source device comprising:
a planar fluorescent lamp having discharge spaces, the planar fluorescent lamp emitting light; and
a luminance enhancing film attached to the planar fluorescent lamp.

2. The planar light source device of claim 1, wherein the planar fluorescent lamp comprises:
a first substrate having a plate shape;
a second substrate having a substantially same shape as the first substrate, the second substrate being combined with the first substrate to define an inner space between the first and second substrates;
a sealing member disposed along edges of the first and second substrates to combine the first and second substrates; and
at least one partition member disposed between the first and second substrates to divide the inner space into the discharge spaces.

3. The planar light source device of claim 2, wherein the luminance enhancing film is attached to an outer surface of the second substrate.

4. The planar light source device of claim 3, wherein the second substrate comprises light diffusing beads.

5. The planar light source device of claim 4, wherein the diffusing beads comprise polymethyl methacrylate (PMMA).

6. The planar light source device of claim 2, wherein the planar fluorescent lamp comprises a connection path that connects the discharge spaces.

7. The planar light source device of claim 6, wherein at least one end portion of the at least one partition member is spaced apart from the sealing member to define the connection path.

8. The planar light source device of claim 6, wherein the at least one partition member includes an orifice corresponding to the connection path.

9. The planar light source device of claim 2, wherein the planar fluorescent lamp further comprises a first electrode and a second electrode that apply discharge voltages to the discharge spaces.

10. The planar light source device of claim 9, wherein the first and second electrodes are disposed at first and second end portions of the planar fluorescent lamp, respectively, such that a longitudinal direction of the first and second electrodes is substantially perpendicular to a longitudinal direction of the at least one partition member, and the first and second electrodes each cross all of the discharge spaces.

11. The planar light source device of claim 10, wherein the first and second electrodes are disposed at an outer surface of at least one of the first and second substrates.

12. The planar light source device of claim 10, wherein the first and second electrodes are disposed at an inner surface of at least one of the first and second substrates.

13. The planar light source device of claim 2, wherein the planar fluorescent lamp further comprises:
a fluorescent layer disposed at an inner surface of each of first and second substrates and a side face of the at least one partition member; and
a light-reflecting layer interposed between the first substrate and the fluorescent layer.

14. The planar light source device of claim 1, further comprising a light diffusing layer interposed between the planar fluorescent lamp and the luminance enhancing film.

15. The planar light source device of claim 14, wherein the light diffusing layer comprises light diffusing beads and a resin for fixing the light diffusing beads to the planar fluorescent lamp.

16. The planar light source device of claim 1, wherein the planar fluorescent lamp comprises light diffusing patterns disposed at a surface of the planar fluorescent lamp, and the light diffusing patterns uniformize luminance of light generated by the planar fluorescent lamp.

17. The planar light source device of claim 1, further comprising an adhesive layer that combines the luminance enhancing film with the planar fluorescent lamp.

18. The planar light source device of claim 1, wherein the luminance enhancing film is a reflective polarizing film corresponding to a dual brightness enhancement film (DBEF) that transmits a P-wave component and reflects an S-wave component.

19. The planar light source device of claim 1, wherein the luminance enhancing film is a cholesteric liquid crystal (CLC) film that reflects light having a specific wavelength and transmits other light.

20. A planar light source device comprising:
a planar fluorescent lamp including a first substrate having a plate shape, a second substrate facing the first substrate, a sealing member disposed along edge portions of the first and second substrates to combine the first and second substrates, and at least one partition member interposed between the first and second substrates to form discharge spaces, the second substrate including light diffusing beads; and
a luminance enhancing film attached to an outer surface of the second substrate.

21. The planar light source device of claim 20, wherein the planar fluorescent lamp comprises a connection path that connects the discharge spaces.

22. The planar light source device of claim 20, wherein the planar fluorescent lamp further comprises a first electrode and a second electrode that apply discharge voltages to the discharge spaces.

23. The planar light source device of claim 22, wherein the first and second electrodes are disposed at first and second end portions of the planar fluorescent lamp, respectively, such that a longitudinal direction of the first and second electrodes is substantially perpendicular to a longitudinal direction of the at least one partition member, and the first and second electrodes cross all of the discharge spaces.

24. The planar light source device of claim 22, wherein the first and second electrodes are disposed at an outer surface of at least one of the first and second substrates.

25. The planar light source device of claim 23, wherein the first and second electrodes are disposed at an inner surface of at least one of the first and second substrates.

26. The planar light source device of claim 20, wherein the planar fluorescent lamp further comprises:
a fluorescent layer disposed at an inner surface of the first and second substrates and a side face of the at least one partition member; and
a light-reflecting layer interposed between the first substrate and the fluorescent layer.

27. The planar light source device of claim 20, wherein the luminance enhancing film is a reflective polarizing film corresponding to a dual brightness enhancement film (DBEF) that transmits a P-wave component and reflects an S-wave component.

28. The planar light source device of claim 20, wherein the luminance enhancing film is a cholesteric liquid crystal (CLC) film that reflects light having a specific wavelength and transmits other light.

29. A liquid crystal display (LCD) device comprising:
a planar light source device including a planar fluorescent lamp having discharge spaces, and a luminance enhancing film attached to the planar fluorescent lamp, the planar fluorescent lamp emitting light;
an LCD panel that displays images using the light; and
an inverter that outputs discharge voltages for driving the planar light source device.

30. The LCD device of claim 29, further comprising an adhesive layer that combines the luminance enhancing film with the planar fluorescent lamp.

31. The LCD device of claim 29, wherein the luminance enhancing film is a reflective polarizing film corresponding to a dual brightness enhancement film (DBEF) that transmits a P-wave component and reflects an S-wave component.

32. The LCD device of claim 29, wherein the luminance enhancing film is a cholesteric liquid crystal (CLC) film that reflects light having a specific wavelength and transmits other light.

33. The LCD device of claim 29, wherein the planar fluorescent lamp comprises:
a first substrate having a plate shape;
a second substrate having a substantially same shape as the first substrate, and the second substrate being combined with the first substrate to define an inner space between the first and second substrates;
a sealing member disposed along edges of the first and second substrates to combine the first and second substrates; and
at least one partition member disposed between the first and second substrates to divide the inner space into the discharge spaces.

34. The LCD device of claim 33, wherein the second substrate comprises light diffusing beads.

35. The LCD device of claim 34, wherein the diffusing beads comprise polymethyl methacrylate (PMMA).

36. The LCD device of claim 33, further comprising a light diffusing layer interposed between the planar fluorescent lamp and the luminance enhancing film.

37. The LCD device of claim 36, wherein the light diffusing layer comprises light diffusing beads and a resin for fixing the beads to the planar fluorescent lamp.

38. The LCD device of claim 33, wherein the planar fluorescent lamp comprises light diffusing patterns disposed at an outer surface of the second substrate, and the light diffusing patterns uniformize luminance of light generated by the planar fluorescent lamp.

39. The LCD device of claim 38, wherein the light diffusing patterns include a first pattern and a second pattern, the first pattern being disposed at a portion of the outer surface of the second substrate corresponding to the discharge spaces, and the second pattern being disposed at a portion of the outer surface of the second substrate corresponding to the at least one partition member.

40. The LCD device of claim 39, wherein the first pattern has a high density and the second pattern has a low density.

41. The LCD device of claim 33, wherein the planar fluorescent lamp comprises a connection path that connects the discharge spaces.

42. The LCD device of claim 33, wherein the planar fluorescent lamp further comprises a first electrode and a second electrode that apply discharge voltages to the discharge spaces, and the first and second electrodes are disposed at first and second end portions of the planar fluorescent lamp, respectively, such that a longitudinal direction of the first and second electrodes is substantially perpendicular to a longitudinal direction of the at least one partition member, and the first and second electrodes each cross all of the discharge spaces.

43. The LCD device of claim 42, wherein the first and second electrodes are disposed at an outer surface of at least one of the first and second substrates.

44. The LCD device of claim 42, wherein the first and second electrodes are disposed at an inner surface of at least one of the first and second substrates.

45. The LCD device of claim 33, wherein the planar fluorescent lamp further comprises:
a fluorescent layer disposed at an inner surface of the first and second substrates and a side face of the at least one partition member; and
a light-reflecting layer interposed between the first substrate and the fluorescent layer.

46. The LCD device of claim 29, further comprising:
a receiving container that receives the planar light source device; and
a fixing member that fixes the planar light source device to the receiving container.

47. The LCD device of claim 29, further comprising an optical sheet interposed between the planar light source device and the LCD panel.
